(19) United States
(12) Patent Application Publication
(10) Pub. No.: US 2004/0052350 A1
(43) Pub. Date: Mar. 18, 2004

(54) System and method for delivering enhanced voice and data services in parallel with an incumbent phone company

(76) Inventor: Jon Jaroker, New York, NY (US)

Correspondence Address: FAY KAPLUN & MARCIN, LLP, Suite 702, 150 Broadway, New York, NY, 10038, US

(21) Appl. No.: 10/243,539

(22) Filed: Sep. 13, 2002

(51) Int. Cl. H04M 3/42

(52) U.S. Cl. 379/201.02; 379/207.02

(57) ABSTRACT

A method, comprising the steps of receiving a communication originally directed to a POTS line by a service platform, the communication including ANI information and DNIS information, identifying a customer of the service platform using the DNIS information, accessing a customer profile to determine a type of service to be provided to the customer and routing the communication to a device connected to the original POTS line to which the communication was directed.

### BACKGROUND INFORMATION

Local telephone companies offer Call Forward on Busy (“CFB”), Call Forward on No Answer (“CFNA”), Call Forwarding (“CF”); Distinctive Ring and other services. FIG. 1 shows the call flow of a traditional phone system 1 which may offer the services described above. When a user of the traditional phone system 1 places a call, the system has an Automatic Number Identification (“ANI”) service 10 that identifies the number from which the call has been placed. Similarly, the traditional phone system has a Dialed Number Identification Service (“DNIS”) service 20 which identifies the number that the caller dialed. This information is received by the local phone company 30 and the call is directed to the receiving phone which is termed a Plain Old Telephone Service (“POTS”) device 40 which is connected to the phone company by a “POTS line.”

### SUMMARY OF THE INVENTION

A method, comprising the steps of receiving a communication originally directed to a POTS line by a service platform, the communication including ANI information and DNIS information, identifying a customer of the service platform using the DNIS information, accessing a customer profile to determine a type of service to be provided to the customer and routing the communication to a device connected to the original POTS line to which the communication was directed.

In addition, a system, comprising a device configured to receive a communication and a service platform configured to receive the communication originally directed to a POTS line and simultaneously route the communication to the device and a further device connected to the original POTS line.

Furthermore, a method, comprising the steps of receiving a phone call at a central office, the phone call originally directed to a POTS line served by the central office, forwarding the call to a service platform, and routing the phone call to a device connected to the original POTS line, the original POTS line including a distinctive ring number and the service platform routing the phone call to the device via the distinctive ring number.

A service platform, comprising a receiving element configured to receive incoming communications, the communications originally directed to a POTS line, a processing element configured to process the communication in accordance with a type of service selected by a customer and a transmitting element configured to route the communication to a device connected to the original POTS line.

### BRIEF DESCRIPTION OF DRAWINGS

FIG. 1 depicts the call flow of a traditional phone system;

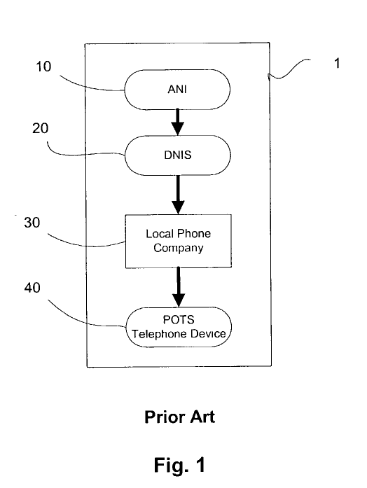

FIG. 2 shows an exemplary platform that may be used to implement the present invention;

FIG. 3 shows an exemplary system for routing an incoming phone call according to the present invention;

FIG. 4 shows an exemplary process for operating a phone system is parallel with a local phone company according to the present invention;

FIG. 5 shows exemplary network architecture and system hardware for routing an incoming phone call according to the present invention.

### DETAILED DESCRIPTION

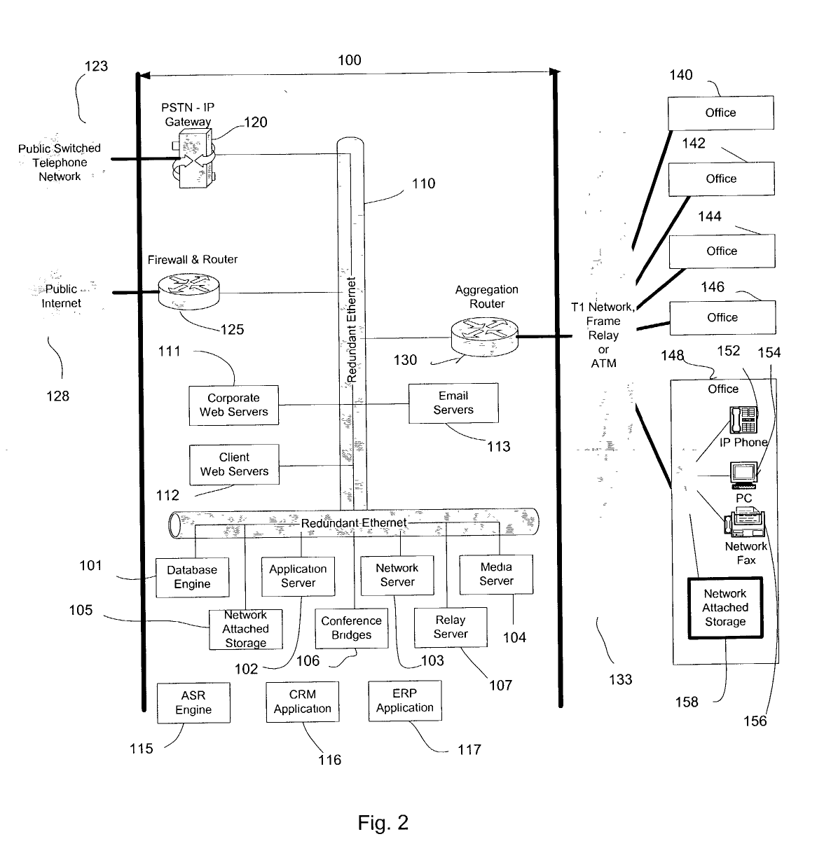

The present invention may be further understood with reference to the following description and the appended drawings, wherein like elements are provided with the same reference numerals. Throughout this description the term Plain Old Telephone Service (“POTS”) is used to describe traditional phone devices and lines. However, this term should be understood to include any manner of phone call delivery or lines that may be provided by a local phone company. FIG. 2 shows an exemplary platform 100 that may be used to implement the present invention. Those of skill in the art will understand that platform 100 is only exemplary and that the present invention may be implemented on numerous other platforms. The platform 100 components in FIG. 2 is shown between the two lines denoting that the platform 100 components may be located within the same facility. However, those of skill in the art will understand that the platform 100 components may be distributed to any physical location. In addition, it may also be considered that the components located at the customer locations 140-148 may also form part of the platform 100.

The platform 100 includes a series of general purpose servers 101-107 which perform specific functions to deliver resources to the users of the platform 100. The resources include database services provided by database server 101, applications provided by application server 102, network service provided by network server 103, media services provided by media server 104, data storage provided by network attached storage 105, conferences services provided by conference bridges 106 and relay services provided by relay server 107. For example, the application server 102 may contain all the call control applications for the platform 100 to manage phone calls. The application server 102 may request resources from the other servers and/or hand off calls to the other servers based on the resource needed to handle the call. Those of skill in the art will understand that these resources and the providing servers are only exemplary, additional servers and/or resources may be added to the platform 100 as needed.

The servers 101-107 are connected to each other and to the remaining components of the platform 100 via a redundant Ethernet 110 (or any other data pipeline) which provides fast and reliable communication between platform components. Other services provided by the platform 100 may include electronic mail (“email”) services via email server 113, corporate and client web services via corporate web server 111 and client web server 112. The platform 100 may also include an automatic speech recognition (“ASR”) engine 115, customer relationship management (“CRM”) applications 116 and enterprise resource planning (“ERP”) applications 117. All of the above resources, services and applications are used to provide service to the customers 140-148 of the platform 100. Those of skill in the art are familiar with the types of services and functions provided by these resources.

The platform 100 may also include a PSTN-IP Gateway 120 which receives phone calls directed for the customers 140-148 from the public switched telephone network (“PSTN”) 123. The phone calls directed from the PSTN 123 may be in the form of analog signals which are converted to digital signals by the PSTN-IP Gateway 120. The conversion of analog signals to digital signals (e.g., data packets) is well known in the art. In the area of telephony, the concept of transmitting voice data in the form of data packets may be referred to as Voice over Internet Protocol (“VoIP”). Throughout this description, the platform for processing and transmitting these data packets may be referred to as VoIP platforms, but those of skill in the art will understand that the Internet Protocol is only one example of protocol which may be used to transmit data over a network and the present invention may be implemented using any protocol for data packet transmission.

The data packets are then distributed to the platform 100 via the redundant Ethernet 110. The resources of the platform 100 perform the necessary processing on the data packets and the phone call (in the form of data packets) is then directed via aggregation router 130 to the correct customer 140-148. The type of processing performed by the platform 100 resources depends on the services provided by the platform 100 and the services for which each customer 140-148 has contracted. Examples of features and services will be described in greater detail below.

The connection from the customer 140-148 locations and the platform location may be via any fast and reliable communication link 133, for example, a Ti circuit, a frame relay network, an asynchronous transfer mode (“ATM”) network, etc. The individual links to customers 140-148 (e.g., T1 links) may be combined into a single digital link (e.g., a DS3 link) between the aggregation router 130 and the communication link 133. The data being sent across the single digital link may need to be multiplexed or de-multiplexed based on the direction of the network traffic and these functions may be carried out by the aggregation router 130. The phone call may then be transferred to an internal network at the customer location, e.g., the network 150 of customer 148, which may distribute the phone call to various devices within the customer location, e.g., IP phone 152, personal computer 154, network facsimile 156 and network attached storage 158.

For example, a third party may be attempting to make a voice phone call from a POTS device (not shown) to the customer 148. The third party will dial a phone number that is related to the customer 148. As will be described in greater detail below, each customer 140-148 may have one or more traditional phone numbers that may be used to contact the customer. The phone call placed by the third party will be routed via the PSTN 123 to the PSTN-IP Gateway 120 of the platform 100. The analog phone call will be converted to a digital signal by the PSTN-IP Gateway 120 and the digital signal will be processed by the various platform 100 resources. The signal will be routed through aggregation router 130 to the communication link 133 and directed to the network 150 of the customer 148. Since this communication is a voice communication, the network 150 may then direct the data packets for the phone call to the IP phone 152 which converts the digital signal into an audio signal for the user to converse with the third party caller. As will be described in greater detail below, customers 140-148 may select the location (or device) to which voice and/or data communications are to be directed, including simultaneously directing communications to multiple devices that are either directly or indirectly connected the platform 100. This entire exemplary communication takes place in the same real time manner as a normal POTS line to POTS line phone call. The fact that the signal is converted to data packets is transparent to both the user of the IP phone 152 and the third party caller.

Similarly, data transmissions from the public internet 128 (or any other communications network) may be routed to the platform 100 through firewall and router 125 which protects the platform 100 from unwanted access. These data transmissions are already in digital form (e.g., data packets) and are passed via the redundant Ethernet 110 to the components of the platform 100 for processing. The platform 100 then transmits the data transmission via the aggregation router 130 and communication link 133 to the customer 140-148 to which the data transmission was directed. For example, a third party may direct an email to an IP address owned by the customer 148. The email communication may be sent via the public internet 128 which directs it to the platform 100 based on the IP address or other alias within the data packets of the email. The email is received and directed through firewall and router 125 and distributed to the various platform 100 resources via the redundant Ethernet 110. In this example, the email may be directed to the email servers 113 where the data packets are processed and to the network attached storage 105 where a copy of the email is stored. Those of skill in the art are familiar with the operation of email servers. The email may then be directed from the email server 113 of the platform 100 via the aggregation router 130 and communication link 133 to the network 150 of the customer 148. In this case since the email is a data communication, the customer 148 may have configured the data communication to be directed to the personal computer 154.

Those of skill in the art will understand that the communication traffic (voice and data) may flow in either direction through the platform 100. Thus, in addition to the examples described above, a customer 140-148 may place a voice phone call that gets directed to the PSTN 123 or send an email that gets directed to the public internet 128. Similarly, customers 140-148 may communicate directly via the platform 100.

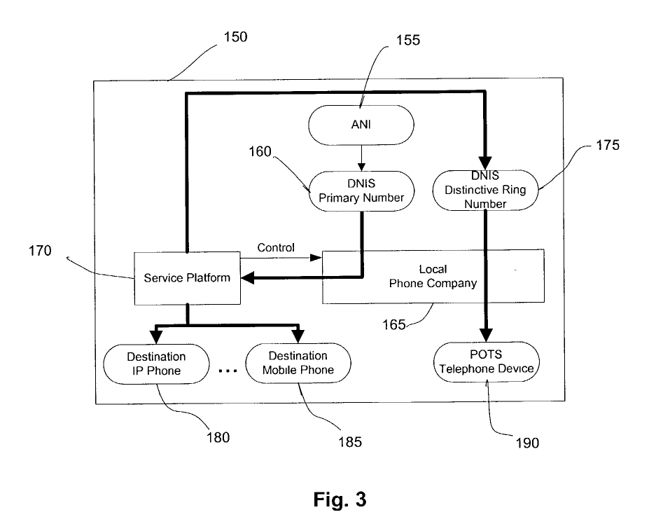

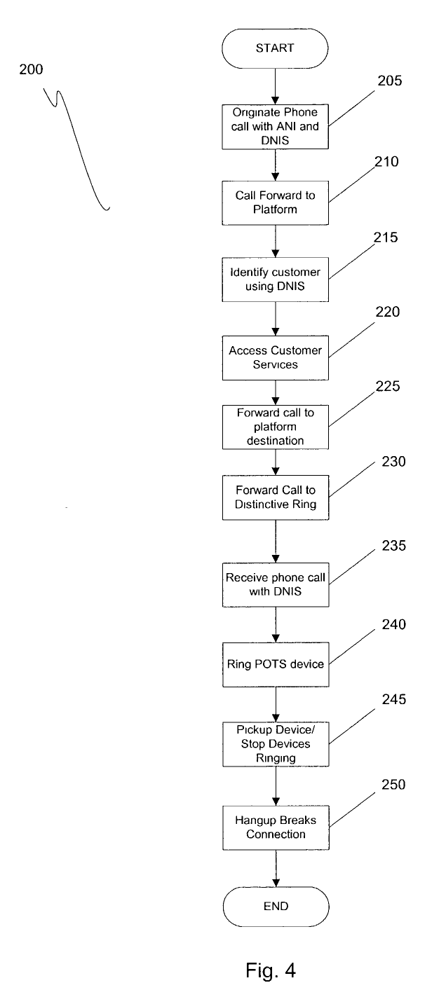

FIG. 3 shows an exemplary system 150 for routing an incoming phone call. The system 150 will be described with reference to FIG. 4 which shows an exemplary process 200 for routing the incoming phone call. In step 205, a phone call is made in the normal manner with the traditional phone system capturing the caller's ANI 155 (e.g., identification of the phone number placing the call) and DNIS 160 (e.g., identification of the number dialed). This phone call is received by the local phone company 165. The call is then forwarded to a telephone number associated with the service platform 170 (step 210) which is, for example, the exemplary platform 100 described with reference to FIG. 2.

For example, the existing phone number of a customer of the service platform 170 may be 555-5000. The customer desires to have its phone service delivered via the service platform 170 rather than via the normal POTS line and POTS device provided by the local phone company 165. The service platform 170 may have a bank of phone numbers to which the phone calls directed to the customers of the service platform 170 may be forwarded in order for the calls to be input into the service platform 170. The customer (or the service platform 170 provider) may purchase the call forwarding service from the local phone company 165. Thus, the phone calls directed to the customer number (e.g., 555-5000) may then be call forwarded to a phone number associated with the service platform 170 so the phone calls may be input into the service platform 170. For example, a third party having the phone number 555-1000 may place a call to the 555-5000 phone number. When this call is received by the local phone company 165 it will contain the ANI information (e.g., 555-1000) and the DNIS information (e.g., 555-5000). The call to the 555-5000 number is received by the local phone company 165, which then forwards the call so the call may be input into the service platform 170.

Those of skill in the art will understand that if the original customer number (e.g., 555-5000) is ported to the service platform 170 provider, there would be no need to use the call forwarding. In this case, the incoming phone call to the original number may be directly terminated on the service platform 170. However, in some instances, phone numbers tend to not be portable. In addition, as will be described below, using the call forwarding service, and the ability to turn off this service, may be used to recover from a failure of the service platform 170.

Continuing with the process 200, when the phone call is received by the service platform 170, it may identify the customer to which the phone call is directed using the DNIS information delivered by the phone company or the customer may already have a phone number from the service platform 170 provider whereby the customer is automatically identified. The service platform 170 may then access a customer profile to determine the particular services and resources which were contracted by the customer and process the phone call accordingly (step 220). The customer profile may be, for example, a file, a database record, etc. As will be described in greater detail below, this processing may involve the use of the ANI relayed to the service platform 170 by the local phone company 165. The service platform 170 may then forward the call to the appropriate destination based on the setup of the customer account (step 225). For example, the customer having the number 555-5000 may have setup its account to have phone calls to that number simultaneously ring the destination IP phone 180 and the destination mobile phone 185. Thus, when a phone call is made to the number 555-5000, the destination IP phone 180 and the destination mobile phone 185 may ring simultaneously.

In addition to ringing the platform destination devices (e.g., the destination IP phone 180 and the destination mobile phone 185), the service platform 170 may also ring back to a distinctive ring number 175 used as an alias for the original number (step 230). A distinctive ring service that may be provided by the local phone company 165 allows the splitting of a single POTS phone line (or wire) into several virtual lines, where each different POTS line may have a different class of service. Continuing with the example of the original 555-5000 phone number, the customer (or the service platform 170 provider) may purchase a distinctive ring service from the local phone company 165 which splits the line into two virtual phone lines having two separate numbers (e.g., 555-5000 and 555-6000). This does not effect the 555-5000 number and when that number is dialed the system 150 operates in the same manner as described above. However, the service platform 170, when it receives the phone call, may then also forward the call to the virtual 555-6000 number created by the distinctive ring service.

When the service platform 170 forwards the call to the distinctive ring number (e.g., 555-6000), the call is routed back to the local phone company 165 with the DNIS information for the distinctive ring number and an ANI that may be that of the original caller (not the ANI associated with the service platform 170). In step 235, the local phone company 165 receives the phone call with the DNIS information (e.g., the distinctive ring number of 555-6000). As described above, the distinctive ring number (e.g., 555-6000) may be set up with different services than that of the actual number (e.g., 555-5000). Thus, the distinctive ring number may not have call forwarding and the phone call may then be routed from the local phone company 165 to the POTS telephone device 190 at the customer location (step 240). Thus, at this point the incoming phone call is directed to both the service platform 170 destinations (e.g., the destination IP phone 180 and/or the destination mobile phone 185) and the POTS telephone device 190 simultaneously. Those of skill in the art will understand that the hardware and/or software implementing the method is sufficiently fast that each of the devices will ring simultaneously without any appreciable time delay.

In step 245, the customer may pick up any one of the devices (e.g., the destination IP phone 180, the destination mobile phone 185 or the POTS telephone device 190) to which the call is routed in order to begin conversing with the calling party. When the customer picks up the device, the other devices will stop ringing because the connection is made through the picked up device. The connection will then remain open during the duration of the conversation until the customer hangs up the device and breaks the communication in step 250, thereby ending the process. Those of skill in the art will understand that in addition to picking up the call by the customer, other services such as voice mail may pickup the call at any one of the devices, thereby causing the other devices to stop ringing. The customer may configure the service platform 170 to determine the voice mail associated with the ringing devices that should take precedence in answering a call when the customer does not actually answer the call or, the customer may configure the service platform 170 so that the service platform 170 answers the call and takes voice messages.

Those of skill in the art will also understand that the original called number (e.g., 555-5000 in the above example) may simultaneously forward multiple calls to the service platform 170. For example, the 555-5000 number may be the main number for a business and four different clients may simultaneously call the 555-5000 number. Each of these four calls may be forwarded concurrently to the service platform 170 for processing. The service platform 170 may hold some of the calls in a queue and process them in the order received, may process them according to priority as defined in the customer profile based on the ANI of each call, etc, or may process them all at once by directing each caller to a different device.

As described in the previous paragraph, the call forwarding to the service platform 170 may occur concurrently for multiple phone calls. The service platform 170 may be configured such that “virtual hunt groups” are implemented. For example, multiple phone calls may be forwarded to the service platform 170 without any of the callers receiving a busy signal or other indication of service unavailability. The service platform 170 may then provide any number of multiple services for the forwarding and answering of these calls. For example, the customer may answer the first call that is received. Any subsequent calls may be placed in a queue. The customer, while continuing to engage in the first call, may view the queue via a graphical user interface (“GUI”) that may be displayed, for example, on the customer's PC. The GUI may display the calls in the queue including, for example, the ANI of the call. The customer may then decide to answer the new call, remain on the first call, place the first call on hold, etc. The GUI may be configured to allow these actions (e.g., place current call on hold, etc.) through an interaction with the GUT on the PC rather than the actual phone device being used for the conversation.

In a further example, the virtual hunt group implemented by the service platform 170 may be configured for automatic call distribution as in a call center. In this example, as the calls are forwarded to the service platform 170, the calls may be distributed in a predetermined pattern across several operators (e.g., the first call is directed to operator(1), the second call is directed to operator(2), etc.). Those of skill in the art will understand that there are many variations on such a distribution scheme. For example, if an operator is currently on a call the next call will be forwarded to the next operator in the predetermined pattern, call overflow where another operator takes over answering the phones when one operator is busy, etc. New operators may be plugged into the system by a simple reconfiguration of the virtual hunt group via, for example, a system administrator GUI with access to the service platform 170. All these services may be provided to the customers via their original POTS line(s) which forward calls to the service platform 170. The original POTS line(s) cannot offer any of these such services on their own.

In the system 150, a customer may continue using a traditional phone system in parallel with a VoIP service platform (e.g., platform 100 of FIG. 2). The customer may desire to run the VoIP service platform because it has features and capabilities which cannot be duplicated in the traditional phone system or are too expensive to duplicate in the traditional phone system. However, since VoIP service platforms (and the accompanying data pipelines and destination devices) are emerging technologies, the customer may not have full confidence to completely transfer all phone service to the VoIP service platform without having a reliable backup in the case of a system failure. The system 150 allows the customer to operate the service platform 170 while utilizing the traditional phone system provided by the local phone company 165 as a backup. For example, if there is a problem with the pipeline from the service platform 170 to the destination devices (e.g., the IP phone 180), an incoming phone call will still be received by the customer because, as described above, the POTS telephone device 190 will receive the incoming call.

In a further example, there may be a complete failure of the service platform 170. In this case, the call forwarding on the original number may be turned off so that all calls to the original number are not forwarded to the service platform 170, but are delivered directly to the POTS telephone device 190. In the exemplary system 150, it is indicated that there is a control function between the service platform 170 and the local phone company 165. This control function may be a separate monitoring function of the service platform 170 which is running on different hardware than the normal service platform 170 functions. This monitoring function may alert the local phone company 165 that a failure has occurred in the service platform 170 and the call forwarding should be turned off. The call forwarding may also be turned off whenever the customer wants to bypass the service platform 170.

The above description of the exemplary system 150 focused on a single incoming phone line. However, those of skill in the art will understand that the system 150 may include any number of incoming phone lines that may be forwarded to the service platform. For example, a single customer may have multiple phone lines that direct phone calls to the service platform 170. Multiple customers may also have phone lines that direct phone calls to the service platform 170. As described above, the service platform 170 uses the DNIS information of the called number to distinguish customers. In addition, the POTS telephone device 190 may be a single line device (e.g., telephone) or a multiple line device (e.g., private branch exchange (“PBX”), switchboard, etc.).

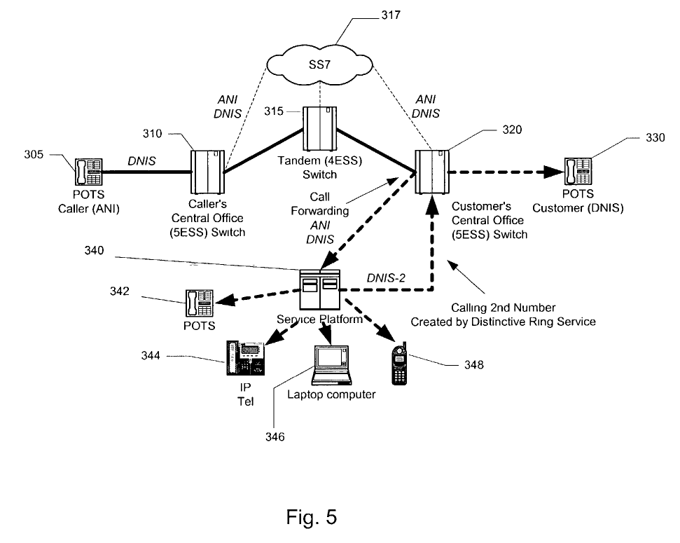

FIG. 5 shows an exemplary network architecture and system hardware for routing an incoming phone call. The hardware shown in FIG. 5 may be used to implement the system 150 and method 200 for routing incoming phone calls described in reference to FIGS. 3 and 4, respectively. In this example, a user of the POTS phone 305 is attempting to call the phone number associated with the POTS phone 330. The user of the POTS phone 330 is a customer of the service platform 340 (e.g., the service platform 100 described in reference to FIG. 2). When the user of POTS phone 305 dials the phone number for the POTS phone 330, this information is sent to the caller's central office switch 310 which is controlled by the local phone company. The call may include both the DNIS (i.e., the number being called) and the ANI (i.e., the number making the call). The central office switch 310 routes the phone call through tandem switch 315 which routes the phone call to the central office switch 320 for the number being called (e.g., POTS phone 330). The ANI and DNIS remain associated with the phone call as it is routed through the series of switches. Those of skill in the art will understand that the tandem switch 315 may be a series of switches based on the ultimate destination of the call. The switches 310, 315 and 320 are shown as using the SS7 protocol 317, but they may implement any protocol for the transport of voice communications.

As described above, the user of POTS phone 330 is a customer of the service platform 340. Thus, the phone call is not directly routed to the POTS phone 330, but is call forwarded to the service platform 340 with the ANI and DNIS. The service platform 340 receives the call and identifies the customer based on the DNIS of the call or directly from a one-to-one association between DNIS and a platform 340 phone number established for this purpose. The service platform may then access the customer profile to determine how the call should be processed and routed. For example, the customer may have set the default routing for all calls to simultaneously ring each of (or some combination of) the POTS phone 342, the IP phone 344, the laptop computer 346 and the mobile phone 348.

In addition, the customer may have also requested that the call simultaneously ring the original called number (e.g., the POTS phone 330). For this to be accomplished, the service platform 340 forwards the call to a distinctive ring number associated with the phone line for the POTS phone 330. As described above, the distinctive ring allows a single phone line to be split into several virtual lines. The forwarded call is sent back to the customer's central office switch 320 with the DNIS for the distinctive ring number. The central office switch 320 then routes the call to the POTS phone 330 including the original ANI. Thus, the single phone call from the POTS phone 305 may cause each of, all of, or any combination of the POTS phone 330, the POTS phone 342, the IP phone 344, the laptop computer 346 and the mobile phone 348 to simultaneously ring until a user answers the call on one of the devices.

As described above, the customers of the service platform 340 may subscribe for various services. However, service platform 340 may allow for simple configuration of services by the user via, for example, a graphical user input (“GUI”) that is accessible, for example, via the laptop computer 346. The services may include specific routing for calls. For example, a customer using the services of the service platform 340 may have an important client to which the customer wants to be available at all times. Thus, the customer may desire to configure the service platform 340 such that, each time a call comes from that client, all of the POTS phone 330, the POTS phone 342, the IP phone 344, the laptop computer 346 and the mobile phone 348 simultaneously ring.

The customer may accomplish this by entering the client's phone number(s) into the service platform 340 via the GUI which, when the information entered in the GUI is saved on the service platform 340, configures the service platform 340 to operate in the specified manner. The service platform, when receiving a call from the client's number(s) may then route the call as desired by the customer. As described above, when the call enters the service platform 340, the DNIS may be used to access the customer profile including the configuration information for the customer. The service platform may then use the ANI of the incoming call to determine whether caller specific routing was specified for calls from that number indicated by the ANI. For example, if the ANI indicated the exemplary client described above, the call would then be routed to all of the POTS phone 330, the POTS phone 342, the IP phone 344, the laptop computer 346 and the mobile phone 348. Whereas, a less important client or personal calls may be routed to only selected devices.

Another feature for which the customer may contract is for password or security code access to phone calls. For example, when the multiple devices are ringing simultaneously, any person at the locations of these devices may pickup the call. This may not be desirable. Thus, the service platform 340 may have a feature whereby, in order to pickup a call that was routed by the service platform 340, a password must be entered into the device. Thus, when a user picks up the handset (or other interface) of a ringing device, the user may be prompted to enter a numerical or other type of password in order to answer the incoming call. This would prevent an unwanted user from picking up a phone call. For example, the customer may have configured the service platform 340 to ring the customer's home phone number when certain calls are received. However, the customer does not want, for example, children picking up these calls. Thus, if such a call were ringing the home phone and a child picked up the receiver, the child could not actually answer the call unless the child entered the correct password.

In the preceding specification, the present invention has been described with reference to specific exemplary embodiments thereof. It will, however, be evident that various modifications and changes may be made thereunto without departing from the broadest spirit and scope of the present invention as set forth in the claims that follow. The specification and drawings are accordingly to be regarded in an illustrative rather than restrictive sense.

What is claimed is:

1. A method, comprising the steps of:
receiving a communication originally directed to a POTS line by a service platform, the communication including ANI information and DNIS information;
identifying a customer of the service platform using the DNIS information;
accessing a customer profile to determine a type of service to be provided to the customer; and
routing the communication to a device connected to the original POTS line to which the communication was directed.

2. The method according to claim 1, wherein the communication is one of a voice communication and a data communication.

3. The method according to claim 1, wherein the device is a traditional phone device.

4. The method according to claim 1, further comprising the step of:
routing the communication to a second device.

5. The method according to claim 4, wherein the second device is one of an IP phone and a computing device.

6. The method according to claim 1, further comprising the step of:
protecting the communication with a password, wherein a user of the device enters the password before accessing the communication.

7. The method according to claim 1, further comprising the step of:
processing the communication using the ANI information.

8. A system, comprising:
a device configured to receive a communication; and
a service platform configured to receive the communication originally directed to a POTS line and simultaneously route the communication to the device and a further device connected to the original POTS line.

9. The system according to claim 8, wherein the device is one of an IP phone and a computing device.

10. The system according to claim 8, wherein the service platform includes a plurality of servers to process the voice communication.

11. The system according to claim 8, wherein the communication is one of a voice communication and a data communication.

12. The system according to claim 8, wherein the communication includes ANI information and DNIS information.

13. The system according to claim 12, wherein the service platform further includes a customer profile, the service platform accessing the customer profile when the DNIS information corresponds to the customer profile and processing the communication in accordance with the customer profile.

14. The system according to claim 13, wherein the customer profile is configured by a customer of the service platform.

15. The system according to claim 12, wherein the service platform processes the communication based on the ANI information.

16. The system according to claim 8, wherein the original POTS line includes a distinctive ring number and the service platform routes the communication to the further device via the distinctive ring number.

17. A method, comprising the steps of:
receiving a phone call at a central office, the phone call originally directed to a POTS line served by the central office;
forwarding the call to a service platform;
routing the phone call to a device connected to the original POTS line, the original POTS line including a distinctive ring number and the service platform routing the phone call to the device via the distinctive ring number.

18. A service platform, comprising:
a receiving element configured to receive incoming communications, the communications originally directed to a POTS line;
a processing element configured to process the communication in accordance with a type of service selected by a customer; and
a transmitting element configured to route the communication to a device connected to the original POTS line.

19. The service platform according to claim 18, wherein the transmitting element is further configured to simultaneously route the communication to a further device separate from the original POTS line.

20. The service platform according to claim 18 further comprising:
a customer profile including the type of service selected by the customer.

21. The service platform according to claim 20, wherein the customer profile includes a graphical user interface, the type of service being configurable via the graphical user interface.

22. The service platform according to claim 18, wherein the receiving element is further configured to receive an additional communication concurrently with the communication.

23. The service platform according to claim 22, wherein the processing element is further configured to process the additional communication in accordance with the type of service selected by the customer.

24. The service platform according to claim 22, wherein the transmitting element is further configured to route the communication to a second device at a first operator station and route the additional communication to a third device at a second operator station.

25. The service platform according to claim 22, wherein the transmitting element is further configured to route the communication to a second device, the processing element is further configured to place the additional communication in a queue, the queue being displayable to a user of the second device.

26. The service platform according to claim 25, wherein the queue is displayed via one of the second device and a third device.
